(19) United States
(12) Patent Application Publication
(10) Pub. No.: US 2025/0011627 A1
(43) Pub. Date: Jan. 9, 2025

(54) DETACHABLE FILM LAMINATE AND METHOD FOR DETACHING PERMANENT ADHESIVE BONDS

(71) Applicant: tesa SE, Norderstedt (DE)

(72) Inventors: Arne KOOPS, Norderstedt (DE); Ingo NEUBERT, Hamburg (DE)

(73) Assignee: tesa SE, Norderstedt (DE)

(21) Appl. No.: 18/577,337

(22) PCT Filed: Jun. 30, 2022
(86) PCT No.: PCT/EP2022/068079

§ 371 Date: Jan. 8, 2024

(30) Foreign Application Priority Data
Jul. 7, 2021 (DE) 102021207161.9

(51) Int. Cl. C09J 7/40; C08K 3/22

(52) U.S. Cl. CPC C09J 7/401; C08K 3/22; C08K 2003/2227; C09J 2203/326; C09J 2203/354; C09J 2301/302; C09J 2301/416; C09J 2301/502; C09J 2400/16; C09J 2433/00; C09J 2467/006

(57) ABSTRACT

The present invention relates to a film laminate which is formed and designed to be separated after permanent adhesive bonding, comprising the following layers: a) a first adhesive compound layer, preferably a contact adhesive layer, b) a first support material, preferably in the form of a film, c) a separating layer, d) optionally a second support material, preferably in the form of a film, e) a second adhesive compound layer, preferably a contact adhesive layer, characterised in that the separating layer—has a thickness of 40 nm to 500 nm,—is black,—has a maximum transmittance of 30%,—consists of a metal which can be at least partially removed by laser radiation, the second adhesive compound layer being translucent to laser beams and/or the first adhesive compound layer and the first support material being translucent to laser beams.

The present invention relates to a film laminate designed and equipped to be separated after long-term adhesive bonding, comprising a first layer of adhesive, a first carrier material, a separation layer, and a second layer of adhesive. The present invention further encompasses a method for parting a long-term adhesive bond produced by means of such a film laminate.

In repair shops and in the end-of-life recycling of electronic devices, the desire to be able to repair electronic devices or else automobiles, or to be able as extensively as possible to disassemble and/or recycle them, is gaining in importance for not just environmental reasons but also economic reasons.

There are different kinds of electronic devices here, differing in their recyclability and also in the degree of recycling:
large household appliances (also called white goods): for example, washing machines, refrigerators and freezers, ovens;
small household appliances (likewise included as white goods): for example, vacuum cleaners, coffee machines, microwaves;
information technology and communication devices: for example, computers, monitors, printers, cell phones, telephones;
consumer electronic devices (also called brown goods): for example, televisions, video recorders, digital cameras.

Electrical and electronic devices in particular contain a multiplicity of substances and materials. If used electrical and electronic devices are disposed of improperly, such as via the household garbage, for example, environmental risks may arise from the pollutants they still contain in some cases. As well as pollutants such as heavy metals and HCFCs, however, used electrical and electronic devices also contain a range of valuable substances, which should be recovered and therefore recirculated. Where, conversely, used electrical and electronic devices are disposed of properly, it is possible to replace primary raw materials (and hence their costly and laborious extraction) and to make a substantial contribution to the preservation of the natural resources.

In order to be able to achieve these objectives, there are specific obligations imposed on all relevant actors (manufacturers, trade, municipalities, owners, waste managers) in Germany by the law governing the sale, return, and environmentally sound disposal of electrical and electronic equipment (Electrical and Electronic Equipment Law—ElektroG) in implementation of Directive 2012/19/EU concerning waste electrical and electronic equipment (WEEE). By avoiding waste, through reasonable tests for possibilities of preparation for the re-use of entire devices or individual components, and by requirements regarding the more extensive recovery of value from wastes, the aim is to achieve a substantial contribution to preserving natural resources and to reducing pollutant emissions.

Corresponding recycling-friendly designs are needed which enable on-demand disassembly (debonding on demand). The recycling-friendly designs include repartable adhesive bonds.

The reason is that, in small electronic devices in particular, there is a very sharply increasing trend toward adhesively bonding parts, usually on a long-term basis, rather than connecting them in a way which can be undone mechanically.

Film laminates in the form of double-sided adhesive tapes are employed, for example, for bonding two components to one another. In general the intention is for these components to be bonded to one another on a long-term basis by such a film laminate. This is intended to result in a correspondingly long life and durability of the bond and/or the product. Examples of components joined to one another in this way are touch panels of the kind employed in computer screens or mobile electronic devices. If one of the two components is damaged, it is completely impossible, or possible only on application of substantial resource (force), to separate the bonded assembly again in order to replace one component. There is also the risk of the component that is not damaged suffering damage in the course of the separation.

DE 10 2020 209 557 A1 discloses a film laminate designed and equipped to be separated after long-term bonding, comprising the following layers:
a first layer of pressure sensitive adhesive,
a separation layer,
a second layer of pressure sensitive adhesive,
   where the separation layer has a thickness of 40 nm to 500 nm, the first layer of pressure sensitive adhesive is laser beam-translucent, and the separation layer consists of a metal which is at least partly removable by laser irradiation.

In this case a metal is removed by laser, leading to the separation.

Translucency is the partial light transmissiveness of a body. The word derives from the Latin lux for light. Wax, the human skin, leaves, and many other substances are translucent, since they transmit light partially, but are not transparent. In delimitation from transparency, translucency may be described as light transmissiveness. The reciprocal property to translucency is opacity. Hence where a substance possesses high translucency, it has low opacity, and vice versa.

Light transmissiveness in the sense of the invention means transmissive at the respective wavelength of the light. This means that, for example, a black body (for example, a black-colored polymer) is opaque in the range of light that is visible for humans, but is translucent in the nonvisible range such as NIR, meaning that radiation in this wavelength range is able to pass through it.

EP 3 390 553 A1 relates to a method for bonding two surfaces by means of a reactive adhesive film system comprising at least two adhesive films (F1 and F2), the adhesive films each comprising at least one reactive component (R1 and R2), the bonding being brought about by a reaction which requires the presence of both reactive components (R1 and R2), where prior to the bonding there is a parting layer (T) which is impervious for the reactive components (R1 and R2) between the adhesive films (F1 and F2) that are to be brought into contact with one another for the reaction. In order to produce the bond, the parting layer (T) is removed over at least part of its area by means of a laser, and so the adhesive films (F1 and F2) come into direct contact with one another and the reaction ensues in the presence of the two reactive components (R1 and R2).

The parting layer may be a metal layer. This may be a metal foil which is introduced between the adhesive films during the production of the adhesive tape, by means of a laminating operation, for example.

EP 3 178 660 B1 discloses a personalizable security element comprising a carrier substrate and an optically variable layer, the security element having the following layer sequence:
a) a carrier substrate consisting of a flexible polymeric film which has a laser-writable black metallic coating or a coating composed of a heat-activatable dye, or of paper which has a direct thermal coating
b) optionally a laminating adhesive layer
c) a layer of a liquid-crystalline material or of a color flop effect varnish.

With regard to the laser-writable black metallization, reference is made to EP 1 567 363 B1.

EP 1 567 363 B1 describes a film which can be inscribed with a laser beam and which has at least one single-layer or multilayer top film transmissive for the laser beam, there being situated below said top film, over at least part of the area thereof, a medium which can be altered by the laser beam and which comprises microscopic metallic particles bound into a matrix material, which give the medium opacity and are destructible via laser exposure such that the medium becomes locally transparent. Microscopic particles are understood to be those whose diameter in the direction of their greatest extent does not substantially exceed 100 μm. The metallic particles endow the medium which can be altered by the laser beam with opacity, but can be destroyed locally by the laser exposure.

The use of lasers for ablation is widespread—for example, in micromachining, certain laser beam sources can be used for ablative operations. Extremely thin layers can be removed from substrates, since the local heating leads to a particulate debris or to carbonization/evaporation. In order to realize ablation operations as sparingly as possible, lasers in the wavelength range from 800 to 2000 nm are primarily employed. For photochemical reactions with low exposure to heat, excimer lasers are frequently used. Excimer laser means that the laser beams are situated in the UV wavelength range.

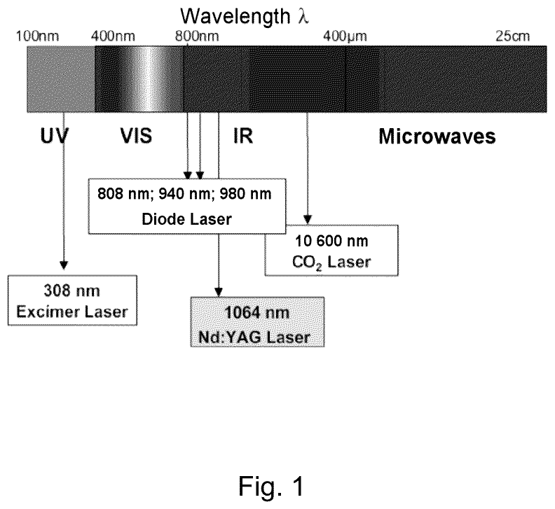

FIG. 1 provides an overview of the emission wavelengths of the principal lasers.

Metal-coated films can be delaminated outstandingly at 1064 μm, since at this wavelength the carrier films typically used (for example, polyesters, polypropylene) are transmissive. The translucency allows the metal layer to be removed without damage to the polymer film. The beam pathway may therefore pass through the film as well. The Nd:YAG laser can be used optimally for areal removal of metallic layers, since the layer is ablated by way of a sublimation.

The table below lists the typical properties of an Nd:YAG laser.

TABLE 1
Typical properties of an Nd:YAG laser

| Wavelength: | 1064 | nm |
|---|---|---|
| Pulse duration: | Several ps up to several ms | |
| Pulse energy: | mJ up to about 100 J | |
| Photon energy | 1.16 | eV |

| | |
|---|---|
| Applications: | Microscale welding, cutting, and |
| | drilling of metals and plastics |
| Note: | Typical plastics and glass possess |
| | high transparency → hence poor machining |

Furthermore, USP (ultra-short pulse) lasers have proven particularly suitable. Ultra-short pulse lasers are laser beam sources which emit pulsed laser light having pulse durations in the range of picoseconds and femtoseconds.

Ultra-short pulse lasers emit pulses of light in which the light energy is compressed to extremely short times, with luminous powers in the megawatt range being achieved during the pulse. By means of appropriate spatial focusing, it is therefore possible to obtain intensities of many gigawatts per square centimeter. At such high intensities, there are nonlinear effects in the interaction between light and matter. One of these effects is that known as multiphoton absorption, which results in virtually any material being ablatable at sufficiently high intensities. This is true particularly of femtosecond lasers. In this case no part is played by their absorption, their hardness or their vaporization temperature, and even challenging materials such as composite materials can be readily machined.

A further advantage of ultra-short pulse lasers is their high precision. Focal diameters in the micrometer range and the low energy input per pulse enable laser ablation with high spatial resolution. The rule here is as follows: the shorter the pulse duration, the less the extent to which the surrounding material is damaged by the laser beam and the more precise the degree of metering with which the material can be ablated. The results are clean cut edges without burring, and so there is no need for reworking. In metal working, nanosecond pulses are usually sufficient; more elaborate machining requires picosecond pulses, while, for nonmetallic materials, such as ceramics, polymers, and many composite materials, femtosecond pulses are employed. The lower level of ablation of material accompanying the shorter pulse duration, however, means that machining takes longer overall. One objective in the current development work on ultra-short pulse lasers, therefore, is to increase the pulse repetition rates (number of laser pulses per second). This will raise the average power and hence the throughput in manufacturing. In the laboratory, femtosecond lasers with an average power of more than 1 kilowatt have already been demonstrated. They have pulse repetition rates of 20 megahertz, pulse energies of 55 microjoules and pulse durations of 600 femtoseconds. Available commercially today there are femtosecond lasers having average powers of not more than a few hundred watts, operating in general with ytterbium-doped laser crystals.

It was an object of the present invention, therefore, to provide a film laminate which on the one hand enables long-term and reliable bonding of two components with one another, but on the other hand, as and when required, enables clean and reliable separation of the components.

The object is achieved in accordance with the invention by means of a laminate as described in claim 1.

The present invention relates accordingly to a film laminate designed and equipped to be separated after long-term adhesive bonding, comprising the following layers:
a) a first layer of adhesive, preferably a pressure sensitive adhesive layer,
b) a first carrier material, preferably in the form of a film,
c) a separation layer,
d) optionally a second carrier material, preferably in the form of a film,
e) a second layer of adhesive, preferably a pressure sensitive adhesive layer.

In accordance with the invention the separation layer is characterized by the following properties:
The separation layer has a thickness of 40 nm to 500 nm.
The separation layer is black.
The separation layer has a transmission of not more than 30%.
The separation layer consists of a metal which is at least partly removable by laser irradiation.

The second layer of adhesive is laser beam-translucent, and/or the first layer of adhesive and the first carrier material are laser beam-translucent.

The object is further achieved by a method for parting a long-term adhesive bond produced by means of a film laminate of the invention, by removing at least part of the area of the separation layer by means of laser irradiation and separating the film laminate into a first part-laminate and a second part-laminate.

Advantageous embodiments of the laminate according to claim 1 and of the method according to claim 7 are reproduced in the dependent claims.

With a film laminate of this kind it is possible for two substrates—for example, glass/glass, glass/metal, glass/plastic, or plastic/plastic—to be permanently bonded. As a result of the controlled removal of the thin metal layer, the composite adhesion between the two layers of (pressure sensitive) adhesive can be reduced to an extent that enables very easy separation of the layers—in the best case, the composite adhesion is eliminated almost entirely. This makes it possible to achieve what is referred to as reworkability, meaning that an adhesive bond which has actually been made as a connection that can no longer be altered can nevertheless be undone again. This removal of the metal layer is accomplished by ablation or sublimation of the metal layer.

The film laminate further comprises, between the first layer of adhesive and the separation layer, a first carrier layer, which may be laser beam-translucent. A carrier layer of this kind makes it possible to ensure particularly effective adhesion of the metal, since the material of the carrier layer can be adapted to the requirements of the metal without any need to have regard to the properties of the layer of adhesive. The material of the carrier layer may be selected such that the adhesion of the metal separation layer is particularly effective.

According to one preferred embodiment, between the second layer of adhesive and the separation layer, the film laminate has a second carrier material which is likewise optionally laser beam-translucent.

The first carrier material is laser beam-translucent together with the first layer of adhesive at least when the second layer of adhesive and/or the second carrier material provided optionally are not laser beam-translucent.

Exactly conversely, the second layer of adhesive and the second carrier material provided optionally are laser beam-translucent when the first carrier material and/or the first layer of adhesive are not laser beam-translucent.

It is particularly preferred, furthermore, if the first carrier material and/or the second carrier material are joined to the separation layer by way of a laminating adhesive.

A laminating adhesive is preferably joined only between the second carrier material and the separation layer.

Laminating adhesives used are the customary, known laminating adhesives. In this way it is possible to coat a carrier layer with the metal and to join the other carrier layer by means of the laminating adhesive, which may also be referred to as laminating adhesive layer.

The present invention further relates to a method for parting a long-term adhesive bond produced by means of a film laminate of the invention, wherein at least part of the area of the separation layer is removed by means of laser irradiation and the film laminate is separated into a first part-laminate and a second part-laminate.

This preferably involves the application, to at least one of the part-laminates, of forces which increase the spacing of the two part-laminates from one another. Accordingly, the film laminate can be separated into two part-laminates in a particularly effective and reliable way.

A typical construction of a film laminate of the invention therefore looks as follows:
a) first layer of pressure sensitive adhesive
b) first carrier layer
c) laminating adhesive layer
d) separation layer
e) laminating adhesive layer
f) second carrier layer
g) second layer of pressure sensitive adhesive,
   where only the layers a), b), d) and g) are mandatory, while the other layers are optional, albeit preferable.

It is important that either the first layer of pressure sensitive adhesive and the first carrier layer are translucent for the laser radiation used, or the second layer of pressure sensitive adhesive, so that the laser is able to reach the separation layer. The same applies to the substrate for bonding, at least on the side from which the laser radiation is introduced. This substrate as well must be transmissive for the laser radiation. The separation layer itself absorbs the laser radiation.

Candidate laminating adhesives are in principle all of the solvent-containing, solvent-free and aqueous laminating adhesives that are known in the prior art, based on various polymers, examples being polyurethane, polyester, polyethylene or ethylene-vinyl acetate. The laminating adhesive is preferably a polyurethane-based laminating adhesive. “Polyurethane-based” means here that a polyurethane or the entirety of multiple polyurethanes form the main constituent of the polymer composition of this laminating adhesive, thus having the largest fraction within the polymer composition.

Solvent-free polyurethane laminating adhesives may take the form of one-component (1K) or two-component (2K) systems. Further differences may arise from the structure of the polyurethane and the nature of the crosslinking. The following polymers are frequently preferred:
1K system: prepolymers of low molecular weight, NCO-terminated, moisture-crosslinking;
2K system: prepolymers having NCO end groups+polyols.

Aromatic isocyanates are frequently used, but present problems in food contact, since in that case it is possible for primary aromatic amines to form. Occasionally, therefore—especially also if UV stability is required—aliphatic isocyanates are employed. In principle, better adhesion and faster curing can be achieved with aromatic isocyanates.

Polyether polyurethanes usually have a higher temperature stability than polyester polyurethanes. Often, however, the polyol component consists of a mixture of polyester polyols and polyether polyols. Frequently, polyols with threefold and higher functionalization are also used, in order to generate additional crosslinking effects, this frequently resulting in turn in higher temperature stability.

The laminating adhesive is preferably a polyether polyurethane-based laminating adhesive founded on a solvent-free 2K system. It has also emerged as being advantageous to subject the faces that are to be bonded to one another to a corona pretreatment prior to bonding.

The laminating adhesive layer(s) are used advantageously in thicknesses of 1 to 10 μm, more preferably in thicknesses of 3 to 5 μm.

The carrier layer or carrier layers of the film laminate consist preferably of polyethylene terephthalate, polyethylene or polypropylene, with biaxially oriented polypropylene (BOPP) or biaxially oriented polyethylene terephthalate (PET) films being particularly preferred. Metals adhere particularly well to PET and PP films. Moreover, PET and PP films are very amenable to vacuum vapor deposition, so simplifying the application of the metal.

The carrier layers may have been colored, in which case it should be ensured that the laser beam transmissiveness remains assured by the substances used for coloring. Particularly suitable for coloring, accordingly, are organic dyes.

The thickness of the respective carrier material is preferably in each case 2 to 100 μm, more preferably 10 to 80 μm, more particularly 12 to 50 μm.

In display bonding in particular, an appearance of metallic lustre is undesirable for adhesive tapes. Adhesive tapes for securing/mounting displays are therefore typically jet-black and have a very high opacity. They also serve as a design element in the displays. The use of black metallization is therefore a subject of this invention.

According to one particularly preferred embodiment of the invention, one of the two carrier layers optionally present is colored black, by means, for example, of a black pigment such as carbon black, more particularly pigmentary carbon black. The use of a black film allows the opacity to be additionally increased.

For the coloration, black pigments are added to the carrier materials.

Suitable black pigments are, for example, carbon black, organic azo dyes and/or chromium complexes. Examples of black pigments based on chromium complexes are [1-[(2-hydroxy-4-nitrophenyl)azo]-2-naphthalenolato(2-)] [1-[(2-hydroxy-5-nitrophenyl)azo]-2-naphthalenolato(2-)]chromate(1-), bis[1-[(2-hydroxy-4-nitrophenyl)azo]-2-naphthalenolato(2-)]chromate(1-), and bis[1-[(2-hydroxy-5-nitrophenyl)azo]-2-naphthalenolato(2-)]chromate(1-).

Black pigments are used preferably in amounts such that the fraction of black pigments does not make up more than 8% by volume.

Black pigments are added particularly in the range from 1.3% to 1.8% by volume.

Where carbon black particles are admixed as black pigments, they are used preferably in an amount of up to 12 wt %, based on the colored adhesive (i.e., the adhesive blended with color pigments). For the coloring achieved to be outstanding, it is advantageous to use carbon black at least in an amount of 1.2 wt %. Very preferably, where carbon black is used as a black pigment, it is employed in an amount such that the carrier material comprises carbon black in a weight fraction of 2.1 to 3.1 wt %.

Suitable carbon blacks are as follows:
pigment black
lamp black
furnace black
furnace black
acetylene black
oxidized gas black
thermal black

The separation layer is configured as a black metal layer, also referred to as metallic layer. In the context of the invention, the term “metal” embraces metals, alloys or metal oxides.

The metal layer may be a metal foil which is introduced during the production of the laminate, by means of a laminating operation, for example. The separation layer may also be realized outstandingly by vapor deposition, sputtering, electrostatic coating or other application of the material in finely divided, atomic, ionic or molecular form, especially for metals, metal oxides or the like. This may take place, for example, on one of the pressure sensitive adhesive layers or on one of the carrier materials.

Very preferably, the separation layer provided in accordance with the invention lies over the whole area and as a continuous layer between the first carrier material and the second adhesive layer or between the first carrier material and the second carrier material. The separation layer may optionally also be in contact with one or two laminating adhesive layers.

The parting layer provided in accordance with the invention is used advantageously in thicknesses of 40 nm up to 500 nm, more preferably in thicknesses of 100 nm to 250 nm.

A particularly suitable metal layer is a layer of Al, Cu, Ag, Au, Pt, Pd, Zn, Cr, Ti and the like, not excluding customary impurities in the metals. Aluminum has emerged as a particularly suitable metal. A layer of an alloy is also within the concept of the invention. An alloy is a macroscopically homogeneous metallic material composed of at least two elements (components), of which at least one is a metal and which jointly have the feature of metal bonding that is typical of metals. With further advantage, layers of copper or titanium or of metal oxide (MeOx layers) may be used as parting layers in the invention. Advantageous metal oxide layers consist, for example, of silicon dioxide (SiO₂), titanium dioxide (TiO₂) or zinc tin oxide (ZnSnO), or they comprise one or more of these metal oxides.

The metal oxides comprise, with further preference, boron oxides, aluminum oxides, molybdates, and vanadates, and include their hydroxides and oxide hydrates or mixtures thereof.

The coating is advantageously deposited in particular by metals—such as, for example, aluminum, copper or titanium—or metal oxides—such as, for example, SiO₂, TiO₂ and/or ZnSnO—over the full area and as a continuous layer. The layer depths generated feature a thickness of 40 nm to 500 nm. The metal layer or metal oxide layer is produced ideally by coating using sputtering processes. Sputtering (sputter coating), also called cathodic atomization under a high vacuum, denotes the ablation or removal in dust form of material from a solid by energetic ion bombardment, to coat a substrate with the material removed in dust form. The magnetron sputtering process, which can be used in the invention, is what is called a PVD process (Physical Vapor Deposition). The stable vacuum coating operation enables high uniformity and purity of the layer. The procedure is preferably such that the coating source (sputter source) generates a low-pressure plasma composed of a noble gas (typically argon), this taking place in a vacuum chamber in the pressure range from 10⁻³ to 10⁻² mbar. The starting material for the layer is known as the target, and is located in the sputter source. The sputter process technology is at a very high level in technical terms and is also suitable as a manufacturing process for mass production. Alternatively, galvanic electrolysis or CVD (Chemical Vapor Deposition) processes can be used for generating the separation layer.

In principle it is also possible to apply two or more layers of different metals.

In accordance with the invention, the metallic separation layer has a transmission of not more than 30%, preferably not more than 20%, more preferably not more than 5%. This means that the majority of the incident laser radiation is absorbed in the separation layer.

For describing the degree of blackening in the sense of the invention, reference is made to EP 1 522 606 A1.

For instrumental capture of the visual impression of the black separation layer, it is advantageous to define ranges of values for the parameters a*, b* and L* in the CIE 1976 L*a*b* color space (DIN EN ISO/CIE 11664-4).

A layer would be absolutely black when L*=0, meaning that no light is reflected.

Values realized for the metallic separation layer for the purposes of the invention are preferably as follows:
L*: <12
a*: −2 to 2.5
b*: −2.5 to 5.5.

According to one advantageous embodiment of the invention, the metallic separation layer consists of aluminum oxide and has a transmission of not more than 20% and/or the above-stated parameters in the CIE 1976 L*a*b* color space.

The separation layer is removed by a laser, more particularly by ablation. The procedure here in particular is such that the laser is beamed through the film laminate from one side. In this case the separation layer may be removed over its whole area, or removal takes place only in one or more regions or in portions. In this way it is possible to control the size intended for the contact area that remains. It is possible in this way to generate a predetermined breakage point, at which separation takes place under little further exposure, whereas initially (that is, after the laser irradiation) a connection is still maintained. Likewise, in the case of complete removal of the separation layer, a 100% parting of the film laminate is possible within less than a second. Substrates originally joined on a long-term basis can therefore be separated very quickly and cleanly from one another in a simple way.

The lasers used may in principle be customary, standard lasers. The laser wavelength used is preferably selected such that the laser radiation is able to emit with maximum transmission through the pressure sensitive adhesive layers and any other layers of the film laminate. In the wavelength range from 800 to 2000 nm, for example, customary pressure sensitive acrylate adhesives have very little, or no, disposition to absorb. In this range, the adhesive systems used in accordance with the invention are also translucent.

Preference is given to using solid state lasers, whose wavelength is outstandingly suitable for the transradiation of customary adhesives and release materials. With particular preference, Nd:YAG solid state lasers are used. An Nd:YAG laser (short for neodymium-doped yttrium aluminum garnet laser) is a solid state laser which as its active medium uses a neodymium-doped YAG crystal and emits mainly infrared radiation with the wavelength 1064 nm. Further transitions exist at 946 nm, 1320 nm and 1444 nm. The wavelength of the light emitted by this laser is situated—as described above-in the region of 1064 μm. This wavelength is not absorbed in general by the adhesive layers used, and so these materials are translucent for the wavelength in question. Moreover, the carrier layers as well—made of polyethylene terephthalate (PET), for example—can have this wavelength beamed through them without suffering damage. Conversion of the radiation to different wavelengths may be performed as and when required by generation of the second (532 nm) and third (355 nm) harmonics. In principle, however, all gas lasers, dye lasers, solids lasers, metal vapor lasers, and excimer lasers having the appropriate wavelengths are suitable.

The sets of laser parameters used for an application, and the associated laser strategy, are dependent on the adhesive systems used (absorbing and nonabsorbing adhesives). Preference is given to using the following parameters:
power: 0.1-12 watts
speed: 100-12 000 mm/sec
frequency: 1-200 KHz
focus: 25-250 μm
pulse time: 30-300 ns

A pressure sensitive adhesive is understood in this specification, as is customary within the general usage, as a material which—in particular at room temperature—is permanently tacky and also adhesive. Characteristics of a pressure sensitive adhesive are that it can be applied by pressure to a substrate and remains adhering there, with no further definition of the pressure to be applied or the period of exposure to this pressure. In certain cases, depending on the precise nature of the pressure sensitive adhesive, the temperature, and the atmospheric humidity and also the substrate, exposure to a minimal pressure of short duration, which does not go beyond gentle contact for a brief moment, is enough to achieve the adhesion effect, while in other cases a longer-term period of exposure to a high pressure may be necessary.

Pressure sensitive adhesives have particular, characteristic viscoelastic properties which result in the permanent tack and adhesiveness.

A characteristic of these adhesives is that when they are mechanically deformed, there are processes of viscous flow and there is also development of elastic forces of resilience. The two processes have a certain relationship to one another in terms of their respective proportion, in dependence not only on the precise composition, the structure, and the degree of crosslinking of the pressure sensitive adhesive under consideration, but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also in a high peel strength. Highly crosslinked systems, crystalline polymers, or polymers with glasslike solidification lack flowable components and are therefore in general devoid of tack or possess only little tack at least.

The proportional elastic forces of resilience are necessary for the attainment of cohesion. They are brought about, for example, by very long-chain macromolecules with a high degree of coiling, and also by physically or chemically crosslinked macromolecules, and they allow the transmission of the forces that act on an adhesive bond. As a result of these forces of resilience, an adhesive bond is able to withstand a long-term load acting on it, in the form of a long-term shearing load, for example, sufficiently over a relatively long time period. For the more precise description and quantification of the extent of elastic and viscous components, and also of the relationship between the components, it is possible to employ the variables of storage modulus (G′) and loss modulus (G″), which can be determined by means of Dynamic Mechanical Analysis (DMA). G′ is a measure of the elastic component, G″ a measure of the viscous component, of a substance. Both variables are dependent on the deformation frequency and the temperature.

The variables can be determined with the aid of a rheometer. In that case, for example, the material under investigation is exposed in a plate/plate arrangement to a sinusoidally oscillating shearing stress. In the case of instruments operating with shear stress control, the deformation is measured as a function of time, and the time offset of this deformation is measured relative to the introduction of the shear stress. This time offset is referred to as phase angle δ.

The storage modulus G′ is defined as follows: G′=( [symbol] /γ)·cos(δ) ( [symbol] =shear stress, γ=deformation, δ=phase angle=phase shift between shear stress vector and deformation vector). The definition of the loss modulus G″ is as follows: G″=( [symbol] /γ)·sin(δ) ( [symbol] =shear stress, γ=deformation, δ=phase angle=phase shift between shear stress vector and deformation vector).

A substance is considered in general to be pressure-sensitively adhesive, and is defined as being pressure-sensitively adhesive for the purposes of this specification, if at room temperature, presently by definition 23° C., in the deformation frequency range from 10 to 10¹ rad/sec, G′ is located at least partly in the range from 10³ to 10⁷ Pa and if G″ likewise is located at least partly within this range. “Partly” means that at least one section of the G′ curve lies within the window described by the deformation frequency range from 10⁰ inclusive up to 10¹ inclusive rad/sec (abscissa) and by the G′ value range from 10³ inclusive up to 10⁷ inclusive Pa (ordinate), and if at least one section of the G″ curve is likewise located within this window.

The two layers of pressure sensitive adhesive preferably comprise at least one polymer selected from the group consisting of poly(meth)acrylates, natural rubber, synthetic rubbers, including more particularly vinylaromatic block copolymers, silicones, polyurethanes, and mixtures of two or more of the above-recited polymers. More preferably the outer layer of pressure sensitive adhesive comprises at least one poly(meth)acrylate. It is preferable, moreover, if at least one of the two pressure sensitive adhesive layers contains at least 40 wt % of one or more poly(meth)acrylates. More particularly the outer layer of pressure sensitive adhesive contains no polymers other than one or more poly(meth)acrylates.

“Poly(meth)acrylates” are understood, in line with the general understanding, to be polymers accessible via radical polymerization of acrylic and/or methylacrylic monomers and also, optionally, further copolymerizable monomers. The term “poly(meth)acrylate” in accordance with the invention encompasses not only polymers based on acrylic acid and derivatives thereof but also those based on acrylic acid and methacrylic acid and derivatives thereof, and those based on methacrylic acid and derivatives thereof, the polymers always including acrylic esters, methacrylic esters, or mixtures of acrylic and methacrylic esters. The poly(meth)acrylates of the outer layer of pressure sensitive adhesive preferably have an average molar mass M_{w} of not more than 2 000 000 g/mol.

The monomers of the poly(meth)acrylates of the outer layer of pressure sensitive adhesive, and their quantitative composition, are preferably selected such that the so-called Fox equation (E1)

$$\frac{1}{{T}_{g}} = {\sum }_{n} \frac{{w}_{n}}{{T}_{g , n}} \qquad ( E1 )$$

(cf. T. G. Fox, Bull. Am. Phys. Soc. 1 (1956) 123) produces a T_{g} value for the polymer of ≤25° C. A value of this kind is particularly advantageous for pressure sensitive adhesives which are used substantially at room temperature.

In equation E1, n represents the serial number of the monomers used, wₙ the mass fraction of the respective monomer n (wt %), and T_{g,}n the respective glass transition temperature of the homopolymer of the respective monomers n, in kelvins.

The two layers of pressure sensitive adhesive preferably comprise one or more poly(meth)acrylates which can be traced back to the following monomer composition:
a) acrylic esters and/or methacrylic esters of the formula (F1)

$${CH}_{2} = C ( {R}^{I} ) ( {COOR}^{II} ) , \qquad ( F1 )$$

where R^{I}═H or CH₃ and R^{II} is an alkyl radical having 1 to 30 C atoms, more preferably having 4 to 14 C atoms, and very preferably having 4 to 9 C atoms;
b) olefinically unsaturated monomers having functional groups which exhibit reactivity with crosslinker substances;
c) optionally further olefinically unsaturated monomers, which are copolymerizable with the monomers (a) and (b).

Examples of monomers a) are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as, for example, isobutyl acrylate, 2-ethylhexyl acrylate, 2-ethylhexyl methacrylate, isooctyl acrylate, isooctyl methacrylate. More preferably R^{II} is a methyl, an n-butyl, and a 2-ethylhexyl group, more particularly an n-butyl and a 2-ethylhexyl group, or the monomers a) are selected from n-butyl acrylate and 2-ethylhexyl acrylate.

The monomers b) are preferably olefinically unsaturated monomers having functional groups which are able to enter into a reaction with epoxide groups. More preferably the monomers b) each contain at least one functional group selected from the group consisting of hydroxyl, carboxyl, sulfonic acid and phosphonic acid groups, acid anhydride functions, epoxide groups, and substituted or unsubstituted amino groups. More particularly the monomers b) are selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, 2-hydroxyethyl acrylate, 3-hydroxypropyl acrylate, 2-hydroxyethyl methacrylate, 3-hydroxypropyl methacrylate, 6-hydroxyhexyl methacrylate, allyl alcohol, glycidyl acrylate, and glycidyl methacrylate. Especially preferably the monomers b) are acrylic acid and/or methacrylic acid, more particularly acrylic acid.

Suitable monomers c) include in principle all vinylically functionalized compounds which are copolymerizable with the monomers a) and the monomers b). Through selection and amount of the monomers c) it is possible advantageously to regulate properties of the pressure sensitive adhesive of the invention.

The monomers c) are more preferably selected from the group consisting of methyl acrylate, ethyl acrylate, n-propyl acrylate, methyl methacrylate, ethyl methacrylate, benzyl acrylate, benzyl methacrylate, sec.-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxy-polyethylene glycol methacrylate 350, methoxy-polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, N,N-dialkyl-substituted amides, especially N,N-dimethylacrylamide, N,N-dimethylmethacrylamide, N-benzylacrylamide, N-isopropylacrylamide, N-tert-butylacrylamide, N-tert-octylacrylamide, N-methylolacrylamide, N-methylolmethacrylamide; additionally acrylonitrile, methacrylonitrile; vinyl ethers such as vinyl methyl ether, ethyl vinyl ether, and vinyl isobutyl ether; vinyl esters such as vinyl acetate; vinyl chloride, vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, 2-polystyrene-ethyl methacrylate (molecular weight M_{w} from 4000 to 13 000 g/mol), and poly(methyl methacrylate)-ethyl methacrylate (M_{w} from 2000 to 8000 g/mol). More particularly the monomer c) is methyl acrylate.

The monomers c) may advantageously also be selected such that they contain functional groups which support radiation-chemical crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide, and allyl acrylate.

With particular preference, where the layers of pressure sensitive adhesive comprise a plurality of poly(meth)acrylates, all of the poly(meth)acrylates in the layers of pressure sensitive adhesive can be traced back to the above-described monomer composition. More particularly, all of the poly(meth)acrylates in the layers of pressure sensitive adhesive can be traced back to a monomer composition consisting of acrylic acid, n-butyl acrylate, 2-ethylhexyl acrylate, and methyl acrylate.

With very particular preference, the poly(meth)acrylate or all of the poly(meth)acrylates in the layers of pressure sensitive adhesive can be traced back to the following monomer composition:
acrylic acid 1 to 10 wt %
methyl acrylate 1 to 15 wt %
2-ethylhexyl acrylate 30 to 60 wt %
n-butyl acrylate 25 to 50 wt %,
   the proportions of the monomers adding up to 100 wt %.

In one embodiment of the invention, the layers of pressure sensitive adhesive comprise at least one tackifying resin, which is selected from the group consisting of pinene resins, indene resins, and rosins, and also their disproportionated, hydrogenated, polymerized, and esterified derivatives and salts; aliphatic and aromatic hydrocarbon resins, terpene resins, terpene-phenol resins, and also mixtures of two or more of the above-recited tackifying resins. Of the hydrocarbon resins, it is possible to employ all resins that are compatible (soluble) with the poly(meth)acrylate in question; reference may be made more particularly to all aliphatic, aromatic, and alkylaromatic hydrocarbon resins, hydrocarbon resins based on pure monomers, hydrogenated hydrocarbon resins, functional hydrocarbon resins, and natural resins, and especially to C₅ to C₉ hydrocarbon resins. With particular preference the layers of pressure sensitive adhesive comprise at least one tackifying resin selected from terpene-phenol resins and C₅ to C₉ hydrocarbon resins. More particularly the layers of pressure sensitive adhesive comprise a terpene-phenol resin.

Substrates particularly suitable for bonding via the adhesive system of the invention are metals, glass and/or plastics. The substrates to be bonded may be alike or different.

In one preferred embodiment, the reactive adhesive system of the invention is used for adhesively bonding metals, glass and plastics. In one particularly preferred embodiment according to the invention, polycarbonates and anodized aluminum are adhesively bonded.

It may possibly be necessary for the surfaces of the substrates that are to be bonded to be pretreated by a physical, chemical and/or physicochemical process. Advantageous here, for example, is the application of a primer or of an adhesion promoter composition.

The metal substrates to be adhesively bonded may generally be fabricated from all commonplace metals and metal alloys. Metals employed preferably are, for example, aluminum, stainless steel, steel, magnesium, zinc, nickel, brass, copper, titanium, ferrous metals, and alloys. The parts to be adhesively bonded may also be constructed of different metals.

Suitable plastics substrates are, for example, acrylonitrile-butadiene-styrene copolymers (ABS), polycarbonates (PC), ABS/PC blends, PMMA, polyamides, glass fiber-reinforced polyamides, polyvinyl chloride, polyvinylene fluoride, cellulose acetate, cycloolefin copolymers, liquid crystal polymers (LCPs), polylactide, polyetherketones, polyetherimide, polyethersulfone, polymethacrylomethylimide, polymethylpentene, polyphenyl ethers, polyphenylene sulfide, polyphthalamide, polyurethanes, polyvinyl acetate, styrene-acrylonitrile copolymers, polyacrylates and/or polymethacrylates, polyoxymethylene, acrylate-styrene-acrylonitrile copolymers, polyethylene, polystyrene, polypropylene and/or polyesters such as, for example, polybutylene terephthalates (PBT) and/or polyethylene terephthalate (PET).

Substrates may have undergone coating, printing, vapor deposition, or sputtering. The substrates to be bonded may take on any desired form which is necessary for the use of the resultant assembly. In the simplest form the substrates are planar.

The film laminate of the invention is present more particularly in the form of a pressure sensitive adhesive tape, specifically a double-sided pressure sensitive adhesive tape.

In the sense of this invention, the general expression “adhesive tape” (pressure sensitive adhesive tape), synonymously also “adhesive strip” (pressure sensitive adhesive strip), embraces all sheetlike structures, such as two-dimensionally extended films or film portions, tapes with extended length and limited width, tape portions and the like, and also, lastly, diecuts or labels.

The adhesive tape therefore has a longitudinal extent (x direction) and a lateral extent (y direction). The adhesive tape also has a thickness (z direction) which runs perpendicularly to the two extents, with the lateral extent and longitudinal extent being greater by a multiple than the thickness. The thickness is very largely the same, preferably exactly the same, over the entire superficial extent of the adhesive tape as defined by length and width.

In order to adjust the properties of the double-sided adhesive tape, it is possible to use various layers of pressure sensitive adhesive or a combination of layers of adhesive and carrier layers. The properties which can be influenced in this way include thickness, stiffness, flexibility, temperature resistance, elasticity, and flame retardance of the adhesive tape. It is, however, also possible to use the same (pressure sensitive) adhesives for the two layers of (pressure sensitive) adhesive.

There are a great multiplicity of possible applications for the film laminate of the invention. The disassembly of touch panels has already been mentioned. In view of the major importance of cell phones, this is a particularly important area of use. On the one hand, there is a desire for very strong and also, in particular, sealing bonding of the displays of cell phones. On the other hand, though, it is frequently necessary for the display to be removed. The film laminate of the invention is outstandingly suitable for this intended use. A further field of use for the present invention is that of security labels. Fundamentally, it is not desirable for security labels to be removable. Nevertheless, there are applications in which a certain degree of security in conjunction with removability is desirable in certain circumstances. Through the use of the present invention, which requires the use of a laser, easy removal is not possible, and so there is a certain protection against manipulation. With appropriate technical effort, however, the label can indeed be parted again.

In the context of the processing of material in roll form, in the operation known as splicing, the present invention may also be employed.

A topic of increasing importance, lastly, is that of “reworkability”. In the automotive industry, for example, the requirements with regard to disposal of the products, individualized by material, at the end of their life cycle are increasing. It is therefore important that components which consist of different materials must be separated into the individual components again before they are disposed of, even if these components were joined to one another “inseparably” beforehand. The present invention enables a very strong and long-term bond between different components, while nevertheless allowing these components to be separated on demand.

The solution according to the invention offers advantages, especially if the separation layer is in direct contact with the two carrier layers or in contact with the preferably non-tacky laminating adhesive layers.

In this case, after the separation procedure, there is no exposed tacky layer present, and so the layers separated cannot stick together again.

### Measurement Methods

The measurements are carried out—unless expressly otherwise mentioned—under test conditions of 23±1° C. and 50±5% relative humidity.

### Molecular Weight

The molecular weight determinations for the number-average molecular weights Mₙ and the weight-average molecular weights M_{w} are made by means of gel permeation chromatography (GPC). The eluent used is THF (tetrahydrofuran) with 0.1 vol % of trifluoroacetic acid. The measurement takes place at 23° C. The precolumn used is PSS-SDV, 10μ, 10³ Å, ID 8.0 mm×50 mm. Separation takes place using the columns PSS-SDV, 10μ, 10³ and also 10⁵ and 10⁷ Å each with ID 8.0 mm×300 mm. The sample concentration is 0.5 g/l, the flow rate 0.5 ml per minute. Calibration is carried out using the commercially available ReadyCal Poly(styrene) high kit from PSS Polymer Standard Service GmbH, Mainz, Germany. Using the Mark-Houwink parameters K and alpha, this is converted universally into polymethyl methacrylate (PMMA), so that the data are reported in PMMA mass equivalents.

The invention is elucidated in more detail below by an example and two figures, without wishing the invention to be restricted as a result.

### EXAMPLES

An FAYb (fiber laser) laser is used which emits at 1.06 μm. The manufacturer of the laser is SUNX/Panasonic Electric Works. The laser is marketed under the designation LP-V10.

The laser is distinguished by the following parameters:

Panasonic LP-V10 Series

| Wavelength | 1060 | nm |
|---|---|---|
| Laser type | Y fiber laser | |
| Laser class | 4 | |
| Focal length | 190 | mm |
| Marking field | 90 × 90 | mm |
| Laser mode | 12 | watts |
| Laser power | single mode | |
| Q-switch | pulsed | |
| Beam quality | M2 = 1.2 | |
| Peak pulse power | 20 | kW |
| Pulse frequency | 1-200 | Hz |
| Pulse duration | 30 | ns |
| Focus size | 50 | μm |
| Deflection rate | 6000 | mm/s |

For producing an adhesive tape of the invention, a black-metallized film with a thickness of 12 μm, consisting of a transparent PET film, is coated on the free surface with an acrylate-based adhesive, with a coat weight of 50 g/m².

The metallic layer consists of aluminum oxide and has a thickness of 100 nm. The transmission of the metallic layer with respect to the laser light used for lasering is 20%.

A second PET film, colored black using carbon black, having a thickness of 12 μm is coated on the bottom face with an acrylate-based adhesive, with a coat weight of 50 g/m². On the top face, the film has a laminating adhesive layer based on polyurethane, with a thickness of 3 μm. This layer is adhesively bonded on the metallic layer.

The double-sided adhesive tape is bonded between two glass bodies, so that these bodies are joined to one another. The glass bodies each have a thickness of 2 mm.

A test matrix composed of laser power, frequency, and deflection rate is used to establish the optimal sublimation of the metallic layer between the two layers of adhesive.

The multilayer assembly is parted through the material-free interlayer that is produced. As a result of the sublimation and the consequent condensation of the gaseous metal vapor on the adhesive, this surface is no longer adhesive. The assembly can therefore be separated.

The following parameters are set on the laser:

| Parameter | | |
|---|---|---|
| Laser power | 3.0% | (=0.36 W) |
| Scan speed | 3000 | mm/sec. |
| Laser pulse cycle | 500 | μs |
| Line width | 0.1 | mm |
| Marking pitch | 0.1 | mm |

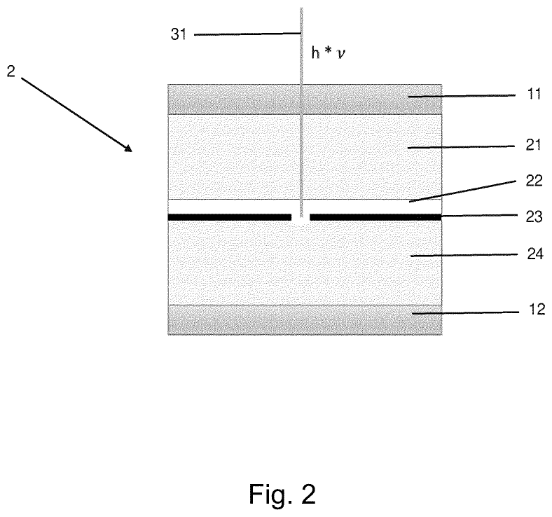

FIG. 2 shows the construction of the double-sided adhesive tape 2 and also the use thereof. The adhesive tape 2 is located between two substrates 11 and 12, which in this case both consist of glass layers.

The adhesive tape 2 has a 12 μm PET film 22 bearing an applied black metallic layer 23 with a thickness of 100 nm. Respective layers 21 and 24 of adhesive are applied to the top and bottom faces of the PET film carrier 22 and metallic layer 23.

The laser beam 31 ablates the metallic layer 23, so passivating the underlying layer 12 of adhesive, leading to a loss of peel adhesion.

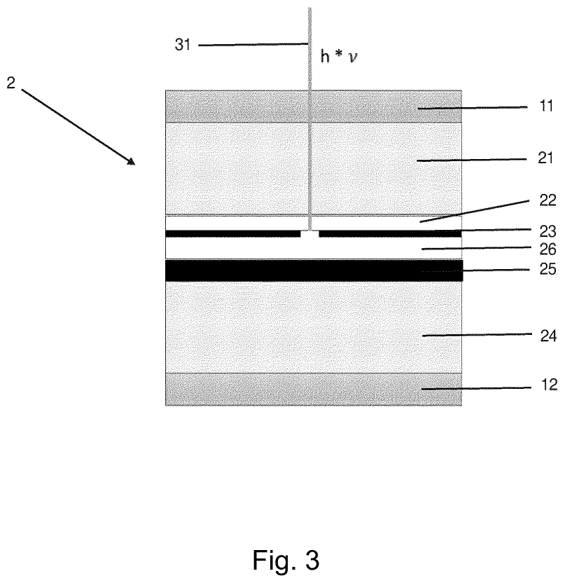

FIG. 3 shows the construction of a variant of the double-sided adhesive tape 2 and also the use thereof. The adhesive tape 2 is located between two substrates 11 and 12, which in this case both consist of glass layers.

The adhesive tape 2 has a 12 μm PET film 22 bearing an applied metallic layer 23 with a thickness of 100 nm. The metallic layer 23 is joined via a non-tacky laminating adhesive layer 26 having a thickness of 3 μm to a black-colored PET film 25 having a thickness of 12 μm.

Respective layers 21 and 24 of adhesive are applied to the first PET film 22 and the second PET film 25, these layers ensuring connection to the substrates.

The laser beam 31 ablates the metallic layer 23, so passivating the underlying layer 12 of adhesive, leading to a loss of peel adhesion.

1. A film laminate designed and equipped to be separated after long-term adhesive bonding, comprising the following layers:
a) a first layer of adhesive,
b) a first carrier material,
c) a separation layer,
d) optionally a second carrier material,
e) a second layer of adhesive,
wherein
the separation layer
has a thickness of 40 nm to 500 nm,
is black,
has a transmission of not more than 30%,
consists of a metal which is at least partly removable by laser irradiation, where the second layer of adhesive is laser beam-translucent and/or the first layer of adhesive and the first carrier material are laser beam-translucent.

2. The film laminate according to claim 1, wherein between the second layer of adhesive and the separation layer, the film laminate has a second carrier material which is likewise optionally laser beam-translucent.

3. The film laminate according to claim 1, wherein the first carrier material and/or the second carrier material are joined to the separation layer by way of a laminating adhesive.

4. The film laminate according to claim 1, wherein the carrier layer or the carrier layers consist of a film of polyethylene terephthalate, polyethylene, or polypropylene.

5. The film laminate according to claim 1, wherein at least one of the two pressure sensitive adhesive layers contains at least 40 wt % of one or more poly(meth)acrylates.

6. The film laminate according to claim 1, wherein the metal comprises a metal, an alloy, or a metal oxide.

7. A method for parting a long-term adhesive bond produced by means of a film laminate according to claim 1, comprising removing at least part of the area of the separation layer by means of laser irradiation and separating the film laminate into a first part-laminate and a second part-laminate.

8. The method according to claim 7, which further comprising applying forces to at least one of the part-laminates that increase a spacing of the two part-laminates from one another.

9. The method according to claim 7, wherein an infrared laser is used for the laser irradiation.

10. The method according to claim 7, wherein a whole area of the separation layer is removed.

11. A composite comprising an automotive component bonded to a film laminate according to claim 1.

12. A composite comprising an electronics component bonded to a film laminate according to claim 1.

13. The film laminate according to claim 1, comprising the following layers:
a) a first layer of a pressure sensitive adhesive layer,
b) a first carrier material in the form of a film,
c) a separation layer,
d) optionally a second carrier material in the form of a film,
e) a second layer of a pressure sensitive adhesive layer.

14. The film laminate according to claim 4, wherein the carrier layer or the carrier layers consist of a film of polyethylene terephthalate.

15. The film laminate according to claim 6, wherein the metal comprises aluminum oxide.
